(19) United States
(12) Patent Application Publication
(10) Pub. No.: US 2025/0319483 A1
(43) Pub. Date: Oct. 16, 2025

(54) WATER OUTLET STRUCTURE CONFIGURED TO FORM SPIRAL GRANULAR WATER AND WATER OUTLET DEVICE

(71) Applicant: Xiamen Solex High-Tech Industries Co., Ltd., Xiamen (CN)

(72) Inventors: Xiaolong LIN, Xiamen (CN); Yong GAO, Xiamen (CN); Fengde LIN, Xiamen (CN); Donghai CHEN, Xiamen (CN)

(21) Appl. No.: 18/827,930

(22) Filed: Sep. 9, 2024

(30) Foreign Application Priority Data
Apr. 15, 2024 (CN) 202410451227.1

(51) Int. Cl. B05B 3/04

(52) U.S. Cl. CPC B05B 3/0444

(57) ABSTRACT

A water outlet structure configured to form spiral granular water includes a rotor, and a water outlet nozzle. The rotor is configured to drive the water outlet nozzle to rotate eccentrically relative to the rotor. The water outlet nozzle has a water flow channel, and the water outlet nozzle comprises a flow straightening piece extending in the water flow channel along a water outlet direction.

### RELATED APPLICATIONS

This application claims priority to Chinese patent application number 202410451227.1, filed on Apr. 15, 2024. Chinese patent application number 202410451227.1 is incorporated herein by reference.

### FIELD OF THE DISCLOSURE

The present disclosure relates to a sanitary product, in particular to a water outlet device.

### BACKGROUND OF THE DISCLOSURE

Showerheads are common bathroom fixtures. Traditional showerheads typically have a single spray function with a relatively simple water spray pattern. Existing showerheads have added the capability to spray granular water, such as described in Chinese patent application number CN201520434216.9, which discloses a granular water showerhead. This showerhead comprises a water outlet cover, and an inner side of the water outlet cover has a first water outlet zone. The first water outlet zone comprises a plurality of water outlet hole groups arranged concentrically. Each of the plurality of water outlet hole groups comprises an outer water outlet hole and an inner water outlet hole. Water flow directions of the outer water outlet hole and the inner water outlet hole are skewed relative to a central axis and in opposite directions. Water flow impacts the rotor, causing a flow from the outer water outlet hole and the inner water outlet hole to interweave and collide, forming granular water. However, the impact force of the water flow in this granular water showerhead is diminished by components such as the rotor, resulting in a shorter spray distance and a smaller spray range. Additionally, the particle size of this showerhead is relatively small, making it difficult to achieve a massage effect.

### BRIEF SUMMARY OF THE DISCLOSURE

The technical problem to be solved by the present disclosure is to provide a water outlet structure that can produce a spiral granular water spray with large water particles and strong impact force.

In order to solve the above technical problems, the present disclosure provides a water outlet structure configured to form spiral granular water comprising a rotor and a water outlet nozzle. The rotor is configured to drive the water outlet nozzle to rotate eccentrically relative to the rotor, and the water outlet nozzle has a water flow channel. The water outlet nozzle comprises a flow straightening piece extending in the water flow channel along a water outlet direction.

In a preferred embodiment, the flow straightening piece is integrally formed with the water outlet nozzle.

In a preferred embodiment, the flow straightening piece and the water outlet nozzle are two separate parts, and the flow straightening piece is mounted inside the water outlet nozzle.

In a preferred embodiment, a distal end of the flow straightening piece is spaced apart from a distal end of the water flow channel by a specific distance.

In a preferred embodiment, an angle is formed between an axis of the water outlet nozzle and an axis of the rotor.

In a preferred embodiment, the angle is an acute angle.

In a preferred embodiment, the flow straightening piece is arranged along an axial direction of the water flow channel.

In a preferred embodiment, the water outlet nozzle comprises a connecting portion connected to the rotor and a water outlet portion extending along an axial direction of the water outlet nozzle. The water flow channel is located in the water outlet portion, and a side wall of the water outlet nozzle comprises a water inlet hole located between the connecting portion and the water outlet portion.

In a preferred embodiment, the rotor has a through-hole along a thickness direction of the rotor for installing the water outlet nozzle, and the water outlet nozzle is penetrated by the water flow channel along an axial direction of the water outlet nozzle, so the water flow channel passes through the through-hole.

The present disclosure provides a water outlet device comprising a water outlet device body, a cover assembly, and one or more of the water outlet structures. The cover assembly is disposed in the water outlet device body and comprises a chamber for receiving the one or more of the water outlet structures.

In a preferred embodiment, the cover assembly has a water inlet port and a flow passing channel connected to the water inlet port and the water flow channel, and the rotor is disposed in the flow passing channel and is driven by a water flow to rotate around an axis of the rotor.

In a preferred embodiment, the cover assembly comprises a front cover and a back cover, and the back cover has a first mounting hole corresponding to the rotor. The front cover has a second mounting hole corresponding to the water outlet nozzle, and a sealing ring is disposed between a side wall of the water outlet nozzle and an inner wall of the second mounting hole.

Compared with the existing techniques, the technical solution has the following advantages.

The present disclosure provides the water outlet structure configured to form the spiral granular water. When the rotor drives the water outlet nozzle to rotate eccentrically, a centrifugal force generated by the rotating water outlet nozzle throws a water column flowing out of the water flow channel into granular water. Furthermore, since the water outlet nozzle is maintained in a rotating state, the granular water forms a spiral granular distribution to form the spiral granular water as the water outlet nozzle rotates. Moreover, the flow straightening piece in the water flow channel of the water outlet nozzle reduces turbulence, resulting in the spiral granular water having larger water particles, stronger impact force, and lower temperature drop, significantly enhancing a shower experience of a user.

### BRIEF DESCRIPTION OF THE DRAWINGS

FIG. 1 is a schematic diagram of a showerhead in Embodiment 1 of the present disclosure.

FIG. 2 is an exploded view of the showerhead in Embodiment 1 of the present disclosure.

FIG. 3 is a cross-sectional view of the showerhead in Embodiment 1 of the present disclosure.

FIG. 4 is a cross-sectional view of a water outlet nozzle in Embodiment 1 of the present disclosure.

FIG. 5 is a schematic diagram showing a water flow effect without a flow straightening piece in Embodiment 1 of the present disclosure.

FIG. 6 is a schematic diagram showing the water flow effect with the flow straightening piece in Embodiment 1 of the present disclosure.

FIG. 7 is a particle size analysis chart of conventional granular water.

FIG. 8 is a particle size analysis chart of spiral granular water.

FIG. 9 is a cross-sectional view of a water outlet nozzle in Embodiment 2 of the present disclosure.

FIG. 10 is a cross-sectional view of the showerhead in Embodiment 2 of the present disclosure.

### DETAILED DESCRIPTION OF THE EMBODIMENTS

The following will clearly and completely describe the technical solutions in the embodiments of the present disclosure with reference to the accompanying drawings. Obviously, the described embodiments are only a portion of the embodiments of the present disclosure, and not all of the embodiments. Based on the embodiments of the present disclosure, all other embodiments obtained by those of ordinary skill in the art without creative work fall within the protection scope of the present disclosure.

In the description of the present disclosure, it should be noted that the terms “upper”, “lower”, “inner”, “outer”, “top end”, “bottom end”, etc. indicate the orientation or positional relationship based on the orientation shown in the drawings. The positional relationship is only for the convenience of describing the present disclosure and simplifying the description, rather than indicating or implying that the referenced device or element must have a specific orientation, be constructed, and be operated in a specific orientation. Therefore, the positional relationship should not be understood as a limitation of the present disclosure. In addition, the terms “first” and “second” are only used for descriptive purposes and should not be understood as indicating or implying relative importance.

In the description of the present disclosure, it should be noted that the terms “installed”, “provided with”, “sleeved/connected”, “connected”, etc., should be understood broadly. For example, “connected” can be a wall hanging connection, a detachable connection, an integral connection, a mechanical connection, an electrical connection, a direct connection, or an indirect connection through an intermediate medium, and it can be a connection in two members. For those of ordinary skill in the art, the specific meaning of the above terms in the present disclosure can be understood under specific conditions.

### Embodiment 1

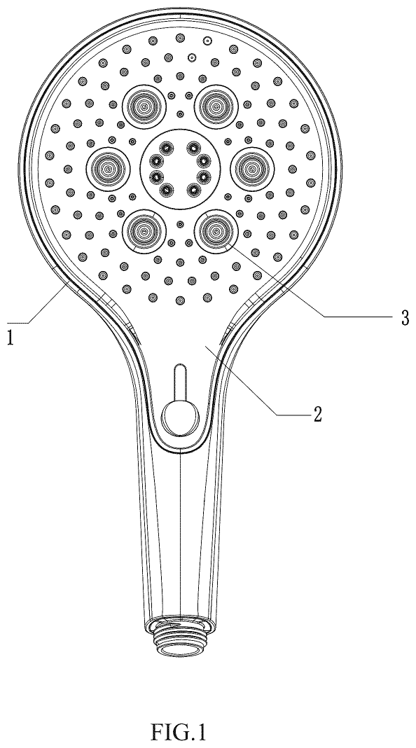

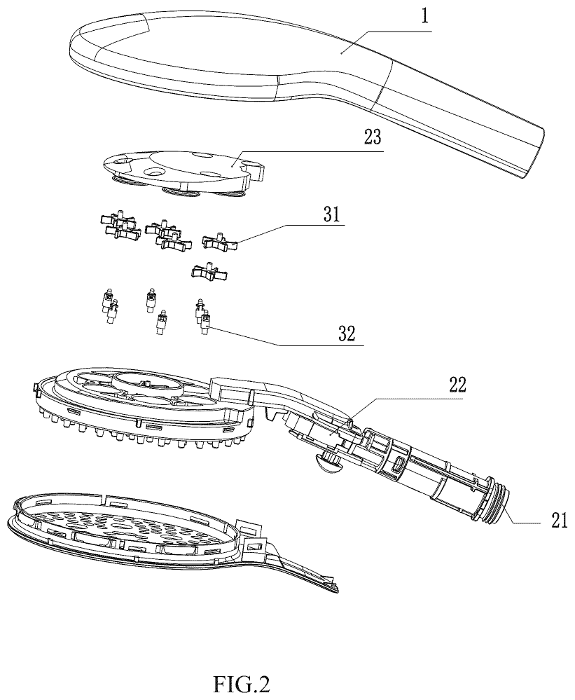

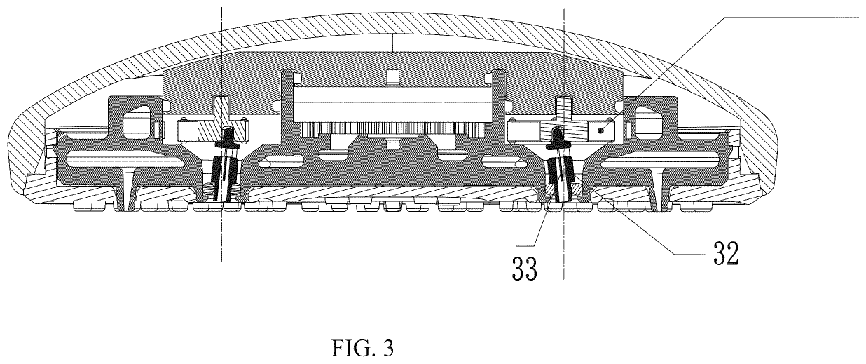

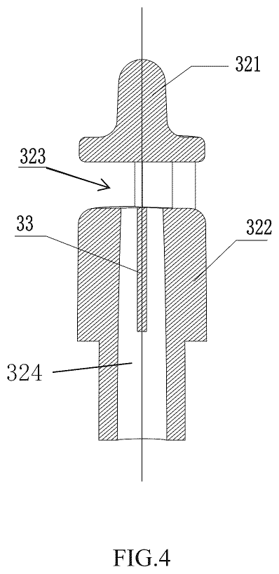

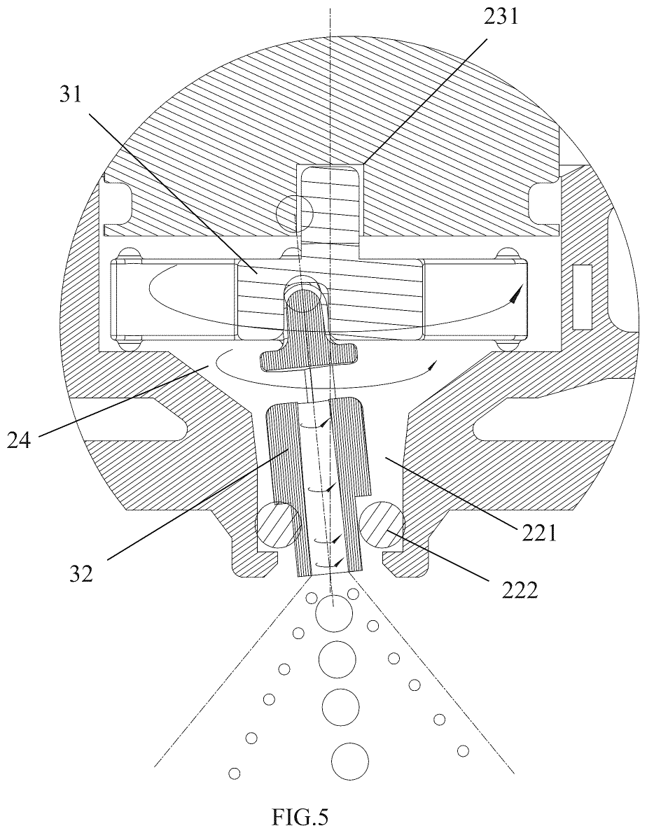

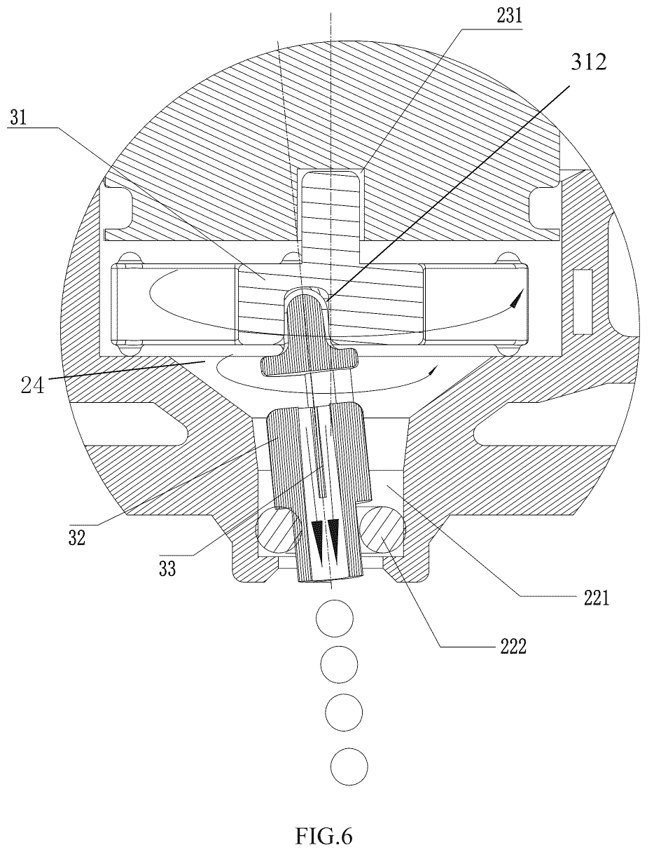

Referring to FIGS. 1-6, this embodiment provides a water outlet device, and the water outlet device comprises a water outlet device body 1, a cover assembly 2, and a water outlet structure 3 configured to form spiral granular water. The cover assembly 2 is disposed in the water outlet device body 1 and comprises a chamber for receiving the water outlet structure 3. In this embodiment, the water outlet device is a handheld showerhead, but the water outlet device can also be other water outlet devices such as faucets or overhead showerheads as a simple replacement.

To form the spiral granular water, the water outlet structure 3 comprises a rotor 31 and a water outlet nozzle 32. The rotor 31 is configured to drive the water outlet nozzle 32 to rotate eccentrically relative to the rotor 31. The water outlet nozzle 32 has a water flow channel 324, and the water outlet nozzle 32 comprises a flow straightening piece 33 extending in the water flow channel 324 along a water outlet direction. When the rotor 31 drives the water outlet nozzle 32 to rotate eccentrically, a centrifugal force generated by the rotating water outlet nozzle 32 throws a water column flowing out of the water flow channel 324 to form granular water. Since the water outlet nozzle 32 is maintained in a rotating state, the granular water is in a spiral distribution to form the spiral granular water as the water outlet nozzle 32 rotates. Moreover, the flow straightening piece 33 in the water flow channel 324 of the water outlet nozzle 32 reduces turbulence, resulting in the spiral granular water having larger water particles, stronger impact force, and lower temperature drop, significantly enhancing a shower experience of a user.

To enable the rotor 31 to drive the water outlet nozzle 32 to rotate eccentrically, the rotor 31 must first be capable of rotating. For this purpose, the cover assembly 2 has a water inlet port 21 and a flow passing channel 24 connected to the water inlet port 21 and the water flow channel 324. The rotor 31 is disposed in the flow passing channel 24 and is driven by a water flow to rotate around an axial direction of the rotor 31.

In this embodiment, the rotor 31 is an impeller, and the water flow in the flow passing channel 24 strikes blades of the impeller laterally, driving the impeller to rotate.

Specifically, the cover assembly 2 comprises a front cover 22 and a back cover 23 arranged along a thickness direction of the water outlet device body 1. The back cover 23 has a first mounting hole 231 corresponding to the rotor 31, and the front cover 22 has a second mounting hole 221 corresponding to the water outlet nozzle 32. A sealing ring 222 is disposed between a side wall of the water outlet nozzle 32 and an inner wall of the second mounting hole 221, allowing the water outlet nozzle 32 to swing within the second mounting hole 221 without water leaking through a gap between the second mounting hole 221 and the water outlet nozzle 32 due to the sealing ring 222.

To achieve an eccentric rotation, driven by the rotor 31, of the water outlet nozzle 32 relative to the rotor 31, the water outlet nozzle 32 comprises a connecting portion 321 connected to the rotor 31 and a water outlet portion 322 extending along an axial direction of the water outlet nozzle 32. The water flow channel 324 is located in the water outlet portion 322, and the side wall of the water outlet nozzle 32 comprises a water inlet hole 323 located between the connecting portion 321 and the water outlet portion 322. An eccentric position on the rotor 31 has an insertion socket 312 into which the connecting portion 321 is inserted, and the insertion socket 312 is inclined relative to the axis of the rotor 31, forming an acute angle between an axis of the water outlet nozzle 32 and the axis of the rotor 31.

A function of the flow straightening piece 33 is to prevent the turbulence in the water flow channel 324, ensuring that the water flows orderly in a direction along which the flow straightening piece 33 extends, without rotating within the water flow channel 324. Therefore, an upper end of the flow straightening piece 33 is disposed at a part of the water outlet portion 322 in communication with the water inlet hole 323, so that the water entering the water outlet portion 322 can be straightened immediately. A distal end of the flow straightening piece 33 is spaced apart from a distal end of the water flow channel 324 for a specific distance. Because the water flow in the water flow channel 324 has already been straightened by the flow straightening piece 33 to form an orderly flow, the flow straightening piece 33 does not need to be too long and only needs to cover part of the water flow channel 324. In this embodiment, the flow straightening piece 33 is arranged along an axial direction of the water flow channel 324.

The flow straightening piece 33 can be integrally formed with the water outlet nozzle 32. Alternatively, the flow straightening piece 33 and the water outlet nozzle 32 can be separate parts, and the flow straightening piece 33 can be mounted inside the water outlet nozzle 32 via a connecting structure.

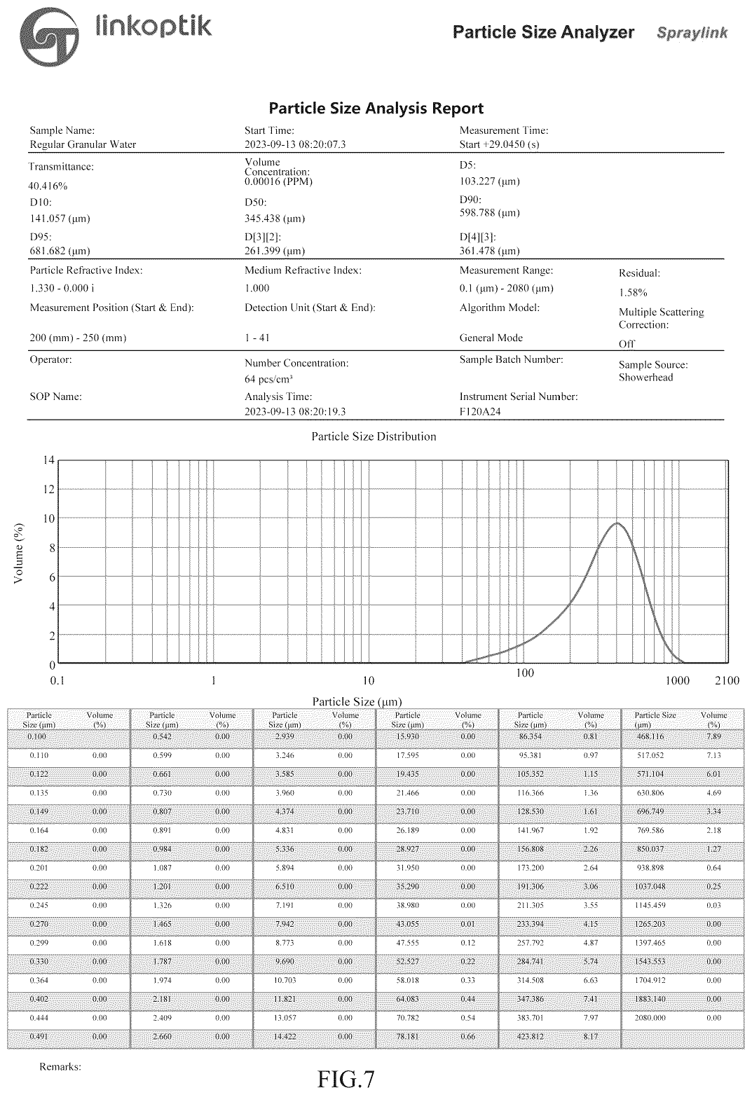

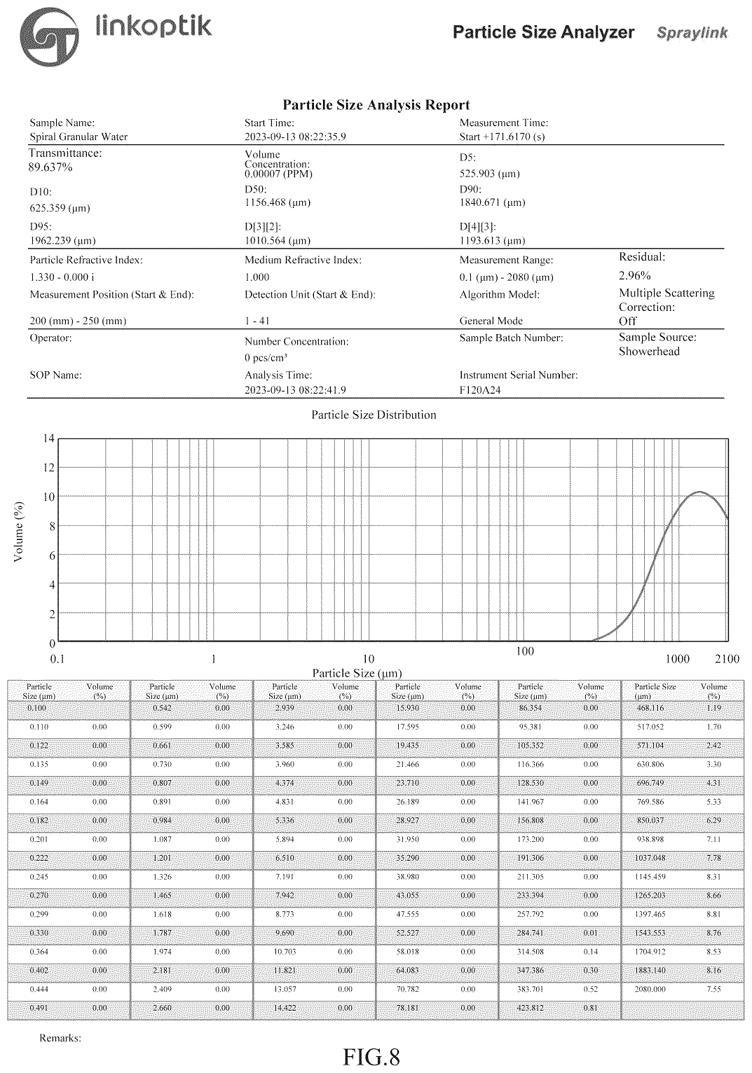

Finally, FIGS. 7 and 8 provide a particle size analysis comparison between conventional granular water and the spiral granular water in this embodiment. It can be seen that a particle size of conventional granular water ranges from 43 μm to 1145 μm, with most particles concentrated between 105 μm and 850 μm. In contrast, a particle size of the spiral granular water ranges from 284 μm to 2080 μm, with most particles concentrated between 468 μm and 2080 μm. In particular, 58.78% of the particles have a diameter exceeding 1145 μm, meaning that nearly 60% of the particles are larger than a maximum particle size of conventional granular water. Therefore, the structure in this embodiment significantly increases the particle size of the water.

### Embodiment 2

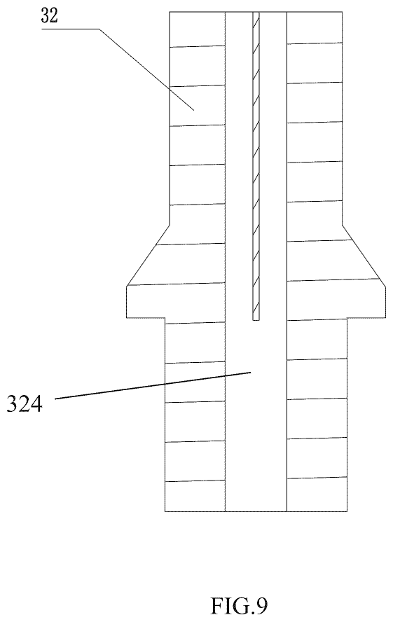

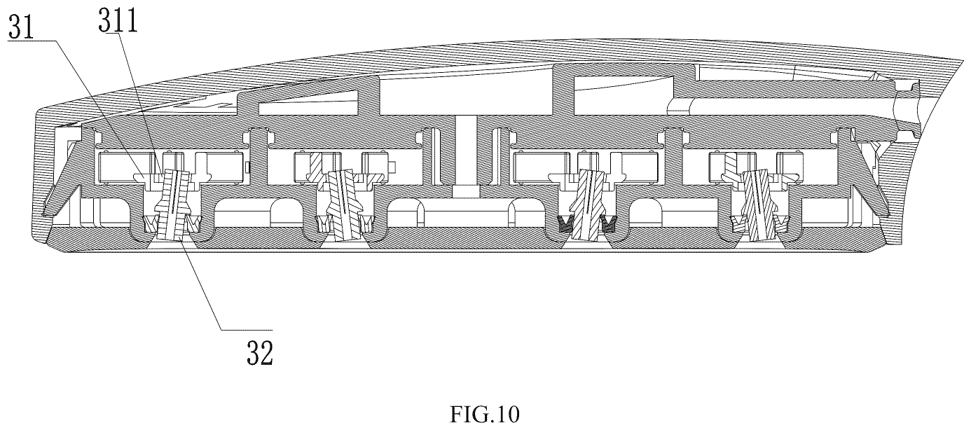

Referring to FIGS. 9 and 10, the difference between this embodiment and Embodiment 1 is that in Embodiment 1, only the water outlet portion 322 of the water outlet nozzle 32 allows the water to pass through, while in Embodiment 2, the water outlet nozzle 32 is penetrated by the water flow channel 324 along the axial direction of the water outlet nozzle 32, allowing the water to flow through the entire nozzle. The water flows into the water flow channel 324 from the rotor 31. In this case, the rotor 31 has a through-hole 311 along a thickness direction of the rotor 31 for installing the water outlet nozzle, so the water flow channel 324 passes through the through-hole 311.

The aforementioned embodiments are merely some embodiments of the present disclosure, and the scope of the disclosure is not limited thereto. Thus, it is intended that the present disclosure cover non-substantive modifications of the present disclosure provided they are made based on the concept within the technical scope disclosed in the present disclosure by any technical person skilled in the art.

What is claimed is:

1. A water outlet structure configured to form spiral granular water, comprising:
a rotor, and
a water outlet nozzle, wherein:
the rotor is configured to drive the water outlet nozzle to rotate eccentrically relative to the rotor,
the water outlet nozzle has a water flow channel, and
the water outlet nozzle comprises a flow straightening piece extending in the water flow channel along a water outlet direction.

2. The water outlet structure configured to form the spiral granular water according to claim 1, wherein:
the flow straightening piece is integrally formed with the water outlet nozzle.

3. The water outlet structure configured to form the spiral granular water according to claim 1, wherein:
the flow straightening piece and the water outlet nozzle are two separate parts, and
the flow straightening piece is mounted inside the water outlet nozzle.

4. The water outlet structure configured to form the spiral granular water according to claim 1, wherein:
a distal end of the flow straightening piece is spaced apart from a distal end of the water flow channel by a specific distance.

5. The water outlet structure configured to form the spiral granular water according to claim 1, wherein:
an angle is formed between an axis of the water outlet nozzle and an axis of the rotor.

6. The water outlet structure configured to form the spiral granular water according to claim 5, wherein:
the angle is an acute angle.

7. The water outlet structure configured to form the spiral granular water according to claim 1, wherein:
the flow straightening piece is arranged along an axial direction of the water flow channel.

8. The water outlet structure configured to form the spiral granular water according to claim 1, wherein:
the water outlet nozzle comprises a connecting portion connected to the rotor and a water outlet portion extending along an axial direction of the water outlet nozzle,
the water flow channel is located in the water outlet portion, and
a side wall of the water outlet nozzle comprises a water inlet hole located between the connecting portion and the water outlet portion.

9. The water outlet structure configured to form the spiral granular water according to claim 1, wherein:
the rotor has a through-hole along a thickness direction of the rotor for installing the water outlet nozzle, and
the water outlet nozzle is penetrated by the water flow channel along an axial direction of the water outlet nozzle, so the water flow channel passes through the through-hole.

10. A water outlet device, comprising:
a water outlet device body,
a cover assembly, and
one or more of the water outlet structures according to claim 1, wherein:
the cover assembly is disposed in the water outlet device body and comprises
a chamber for receiving the one or more of the water outlet structures.

11. The water outlet device according to claim 10, wherein:
a distal end of the flow straightening piece is spaced apart from a distal end of the water flow channel by a specific distance.

12. The water outlet device according to claim 10, wherein:
an angle is formed between an axis of the water outlet nozzle and an axis of the rotor.

13. The water outlet device according to claim 10, wherein:
the flow straightening piece is arranged along an axial direction of the water flow channel.

14. The water outlet device according to claim 10, wherein:
the water outlet nozzle comprises a connecting portion connected to the rotor and a water outlet portion extending along an axial direction of the water outlet nozzle,
the water flow channel is located in the water outlet portion, and
a side wall of the water outlet nozzle comprises a water inlet hole located between the connecting portion and the water outlet portion.

15. The water outlet device according to claim 10, wherein:
the rotor has a through-hole along a thickness direction of the rotor for installing the water outlet nozzle, and
the water outlet nozzle is penetrated by the water flow channel along an axial direction of the water outlet nozzle, so the water flow channel passes through the through-hole.

16. The water outlet device according to claim 10, wherein:
the cover assembly has a water inlet port and a flow passing channel connected to the water inlet port and the water flow channel, and
the rotor is disposed in the flow passing channel and is driven by a water flow to rotate around an axis of the rotor.

17. The water outlet device according to claim 16, wherein:
the rotor has a through-hole along a thickness direction of the rotor for installing the water outlet nozzle, and
the water outlet nozzle is penetrated by the water flow channel along an axial direction of the water outlet nozzle, so the water flow channel passes through the through-hole.

18. The water outlet device according to claim 16, wherein:
an angle is formed between an axis of the water outlet nozzle and an axis of the rotor.

19. The water outlet device according to claim 16, wherein:
the flow straightening piece is arranged along an axial direction of the water flow channel.

20. The water outlet device according to claim 16, wherein:
the cover assembly comprises a front cover and a back cover,
the back cover has a first mounting hole corresponding to the rotor,
the front cover has a second mounting hole corresponding to the water outlet nozzle, and
a sealing ring is disposed between a side wall of the water outlet nozzle and an inner wall of the second mounting hole.
